(19) United States
(12) Patent Application Publication
(10) Pub. No.: US 2008/0250212 A1
(43) Pub. Date: Oct. 9, 2008

(54) METHOD AND APPARATUS FOR ACCESSING MEMORY USING PROGRAMMABLE MEMORY ACCESSING INTERLEAVING RATIO INFORMATION

(75) Inventors: Anthony Asaro, Toronto (CA); Jacky Chun Kit Yan, Markham (CA); Tien D. Luong, Thornhill (CA); Andy Chih-Ping Chen, Markham (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 11/697,978

(22) Filed: Apr. 9, 2007

(51) Int. Cl. G06F 12/00

(52) U.S. Cl. 711/157

(57) ABSTRACT

A method and apparatus stores data representing a non 1:1 memory access interleaving ratio for accessing a plurality of memories. The method and apparatus interleaves memory accesses to at least either a first memory that is accessible via a first (and associated memory) bus having first characteristics or a second memory accessible via a second bus having different characteristics, based on the data representing the non 1:1 interleaving memory access ratio.

### BACKGROUND OF THE DISCLOSURE

The disclosure relates generally to methods and apparatus for accessing pools of memory via buses/memories having different characteristics.

Devices have employed different pools of memory that are accessible via different buses or channels wherein each of the buses may have different characteristics. For example, one bus may have a higher bandwidth and/or higher latency and/or higher power level requirements whereas another memory pool may, for example, be accessible via a bus or channel having a lower bandwidth and/or have a lower latency and/or lower power requirement, or any other suitable combination. By way of example, many devices such as cell phones, laptops, work stations, or other computing systems employ multiple processors such as one or more central processing units (CPUs) and one or more coprocessors such as a graphics coprocessor or other suitable processor. The devices may use a unified memory architecture where a dedicated region of system memory is set aside, for example, for a frame buffer and a separate dedicated memory that is dedicated, for example, to a graphics coprocessor is also used as a frame buffer. Some devices may also employ an integrated graphics processor with a Northbridge on a single integrated circuit which may or may not include the dedicated memory.

When the integrated graphics coprocessor wishes to access frame buffer memory, such as for example, in the system memory, it must send the memory request upstream to the CPU via a bus between the Northbridge and the CPU or some other bus coupled between the graphics processor and the CPU. The request is then serviced by the CPU memory controller and finally data, for example, for a read request is returned back down to the graphics coprocessor using the Northbridge link. Overhead on the link however, can significantly increase the latency for reads to the frame buffer in the system memory and can reduce the performance of the coprocessor. In addition, since the graphics coprocessor may periodically fetch display data from the system memory frame buffer, the CPU may not be able to shut off the link and enter a low power mode less often. This can also reduce the power efficiency of a CPU unnecessarily.

In an effort to alleviate such problems, a dedicated memory bus or memory channel also referred to as a local memory bus or dedicated memory bus, is used by the graphics coprocessor. The dedicated memory bus is coupled to a different memory pool, such as a SDRAM that is local to the graphics coprocessor and is not part of this system memory. Latency for frame buffer access can be reduced since there is no overhead from the Northbridge link to the CPU. Both the local dedicated memory and the shared system frame buffer memory can be enabled simultaneously to provide dual channel performance for frame buffer or other memory accesses.

However, known systems employ a 1:1 memory access interleaving ratio among the system memory frame buffer and the dedicated frame buffer. For example, where the dedicated memory includes two (2) channels that are each used to access for example thirty two (32) megabytes of local SDRAM memory, a memory controller may first use a first bus or channel and dedicated memory portion for a fixed amount of memory locations and switch or interleave to another (second) channel or bus for the same amount of memory and flip back to the first channel a for the next chunk of same size memory (a 1:1 interleave ratio). Such systems typically employ a bit as part of a virtual address to indicate whether the memory controller should access channel A or channel B. However, in systems that employ unified memory architectures in addition to local dedicated memory channels, the different characteristics of the system memory bus versus the dedicated buses can result in different latencies, bandwidth usage and power usage, so that using a 1:1 interleave ratio can still cause bottlenecking to occur. For example, one known system uses a coarse type of balanced interleaving to provide a 1:1 interleaving ratio which uses for example a large section of shared system memory such as thirty two (32) megabytes and then switches to the dedicated memory for a second thirty two (32) megabytes once the first thirty two (32) megabytes in the shared memory have been used.

In addition, 1:1 ratio balancing is also known between system memory frame buffer access and dedicated memory access wherein for example every two hundred fifty six (256) bytes the memory controller of the graphics processor swaps to use the dedicated memory versus 256 bytes of the shared system memory. A single channel bit is typically employed where there are two channels and a channel bit is then removed although it starts as part of the address. However, alternating channels using a lower bandwidth channel and higher bandwidth channel can cause a backup because of the lower bandwidth channel may not be fast enough. It is also known for 1:1 interleaving ratios whether a course approach is used or a fine approach is used, to use for example the system memory for complex game applications and instead and use the dedicated memory for low power applications. However, an undesirable amount of bottlenecking can still occur.

Accordingly a need exists for an improved memory access interleaving method and apparatus.

### BRIEF DESCRIPTION OF THE DRAWINGS

The invention will be more readily understood in view of the following description when accompanied by the figures below and wherein like reference numerals represent like elements:

FIG. 1 is a block diagram illustrating one example of portion of the apparatus that includes circuitry for accessing memory in accordance with one embodiment to the invention;

FIG. 2 is a block diagram illustrating one example of circuitry for accessing memory in accordance with one embodiment of the invention;

FIG. 3 is a diagram illustrating one example of channel select bits and virtual address translation in accordance with one embodiment of the invention;

FIG. 4 is a flow chart illustrating one example of a method for accessing memory in accordance with one embodiment to the invention;

FIG. 5 is a flow chart illustrating one example of a method for accessing memory in accordance with one embodiment to the invention; and

FIG. 6 is a block diagram illustrating another example of a non 1:1 memory access interleaving scheme in accordance with one embodiment of the invention.

### DETAILED DESCRIPTION OF THE DISCLOSURE

Briefly, in one embodiment, a method and apparatus stores data representing a non 1:1 memory access interleaving ratio for accessing a plurality of memories. The method and apparatus interleaves memory accesses to at least either a first memory that is accessible via a first (and associated memory) bus having first characteristics or a second memory accessible via a second bus having different characteristics, based on the data representing the non 1:1 interleaving memory access ratio.

In one embodiment, the method and apparatus processes a virtual address containing memory channel select bits wherein a number of memory channel select bits is greater than or equal to a number of memory buses (also referred to as channels), associated with the combination of the first and second memories. Also in one example, circuitry is provided that includes a programmable register that is programmed to contain data representing the non 1:1 memory access interleaving ratio.

In one example, an apparatus employs the circuitry and also utilizes a unified memory containing frame buffer memory and the local (also referred to as dedicated) frame buffer and interleaves memory accesses between the unified memory frame buffer and the local frame buffer based on the data representing the 1:1 interleaving ratio. Where multiple processors are also employed, the memory controller of one processor may include, for example, the circuitry that facilitates the interleaving of memory access to either a unified memory frame buffer or a local memory frame buffer using the non 1:1 interleaving ratio among the unified memory frame buffer and local frame buffer.

The circuitry can also produce the virtual address with the channel bits and also use the channel select bits of the virtual address to identify which of the first and second memories to access based on a plurality of bits that define the memory access interleaving ratio. A translation from a virtual address to physical address is performed using the non 1:1 interleaving ratio. As such, among other advantages, an apparatus and method may provide an improved memory access scheme that takes into account bus bandwidth differences and/or latency differences and/or power differences, if desired so that non 1:1 memory access interleaving occurs between memories, such as for example, a unified memory based frame buffer and a local frame buffer where multiple processors are employed. Other advantages will also be recognized by those of ordinary skill the art.

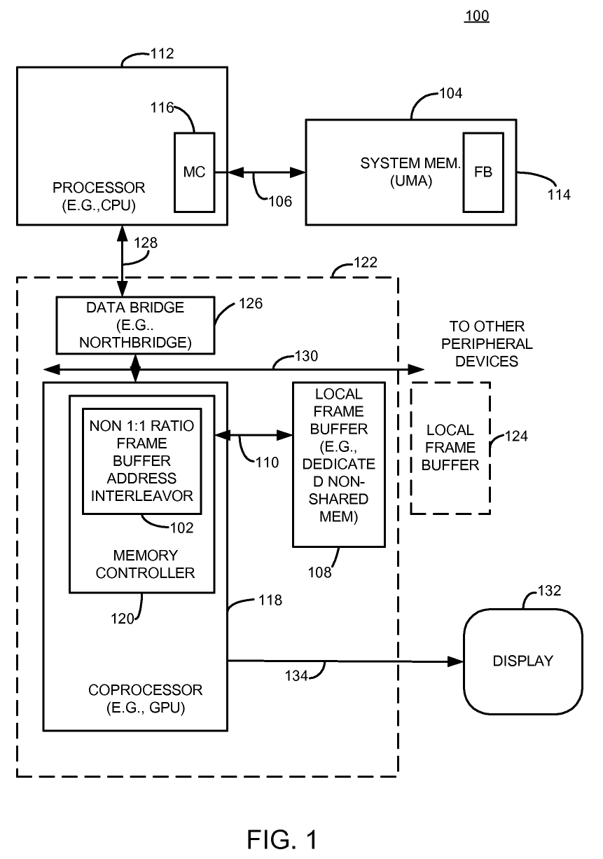

FIG. 1 is a diagram illustrating one example of an apparatus 100 that includes circuitry 102 that is operative to interleave memory access to either a first memory 104 accessible via a first bus 106 having first characteristics, or a second memory 108 accessible via a second bus 110 having different characteristics. The circuitry 102 interleaves memory accesses based on data representing a non 1:1 interleaving memory access ratio. The apparatus 100 may be any suitable apparatus and this example, includes a first processor 112 that is coupled to the first memory 104 via the bus 106. In this example, the memory 104 is a unified memory which is system memory of the apparatus 100 that also has memory locations dedicated as a frame buffer shown as 114. The processor 112 may be, for example, a central processing units (e.g., CPU core), DSP, or any other suitable processor or any other suitable circuit. In this example, the processor 112 also includes a memory controller 116 that controls, reads and writes to and from the memory 104.

The device 100, in this example, also includes a second processor 118 such as a coprocessor such as another CPU, graphics processing unit, or any other suitable processor. The second processor 118 also includes a memory controller 120 that includes the circuitry 102. However, it will be recognized that the circuitry 102 may be contained as part of any suitable portion of the apparatus 100 as desired. The apparatus 100 utilizes the circuitry 102 to determine how to interleave memory accesses among the unified architecture system memory frame buffer and the local or dedicated frame buffer 108 in a non 1:1 interleaving ratio manner. The second processor 118 is coupled to the local memory 108 which in this example, is a local frame buffer memory such as an SDRAM or any other suitable RAM through the bus 110. The dashed lines 122 indicate that the components therein may be integrated in a single monolithic semiconductor integrated circuit or that the local frame buffer 108 may be its own integrated circuit as shown by box 124. In any event, any suitable level of integration may be employed as desired.

The apparatus 100 also includes a data bridge 126 such as a Northbridge or any other suitable data bridge circuit which is coupled to the first processor 112 via a bus 128. The data bridge 126 may also connect with other peripheral devices via the same bus 128 or other bus 130 as known in the art. Also in this example, the apparatus 100 includes a display 132 that displays information 134 provided from the processor 118. In this example, the display 132 displays the information 134 that is stored in either the local frame buffer (memory 108) or the system memory frame buffer 114. The apparatus may be, for example, a printer, a laptop computer, printed circuit board, handheld device such as a cell phone, digital audio player, camera, digital video playing device, or any other suitable structure as desired.

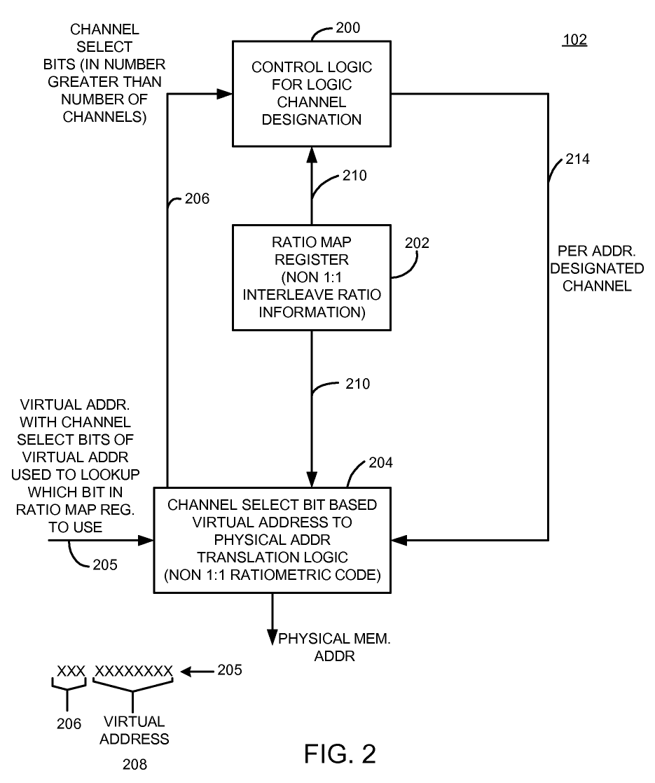

As shown, the memory 104 is shared memory and is coupled to the first processor 112 via the bus 106 and the second memory 108 is local memory to the second processor 118. The first processor 112 may also store information in the memory 108 through buses 128 and 110. The memory controller 120 is operatively coupled to the memory 108, in this example, via bus 110 and the circuitry 102 is operative to use the channel select bits of a virtual address to identify which of the first and second memories 104 and 108 to access based on the plurality of bits that define the memory access interleaving ratio stored in a register, for example, as described with reference to FIG. 2. The memory channel 106 and memory channel or memory bus 110 have different characteristics. In this example, the memory bus 106 is a 128 bit wide bus operating at a frequency of, for example, 400 MHz whereas the bus 16 is a 16 bit wide bus operating at a frequency of 533 MHz. In addition, the buses may have different operating power levels as well as latencies associated with the time it takes between the time a memory request is received and the associated data is returned.

FIG. 2 illustrates in more detail one example of the circuit 102 which includes control logic 200, a programmable register 202 that stores data representing the non 1:1 interleaving ratio and virtual to physical address translation logic 204. In one example, the control logic 200 accesses the data representing the non 1:1 interleaving ratio from the ratio map register 202 and uses it along with channel select bits 206 to determine a logic channel designation. The control logic 200 may be any suitable structure such as a suitably programmed processor, discrete logic or any suitable structure. Accessing data representing the non 1:1 interleaving ratio may include, for example, receiving data or symbols corresponding to this ratio, generating this ratio or accessing memory or registers storing this ratio data. The apparatus 100 utilizes a virtual address structure that employs memory channel select bits 206 in addition to virtual address bits 208 which form the virtual address with channel selection bits 205. The number of channel select bits 206 is greater than or equal to the number of memory buses or memory channels associated with the memory 104 and 108. For example, as shown in FIG. 1, two memory channels or memory buses 106 and 110 are employed to access system memory 104 and local frame buffer memory 108, respectively. As such, there are at least three channel select bits 206 to use as part of the virtual address. However, it will be recognized that any suitable number of channel select bits may be employed that are greater in number than the number of memory channels. As such, the channel select bits are greater in number than the number of memory channels associated with the combination of the first and second memories.

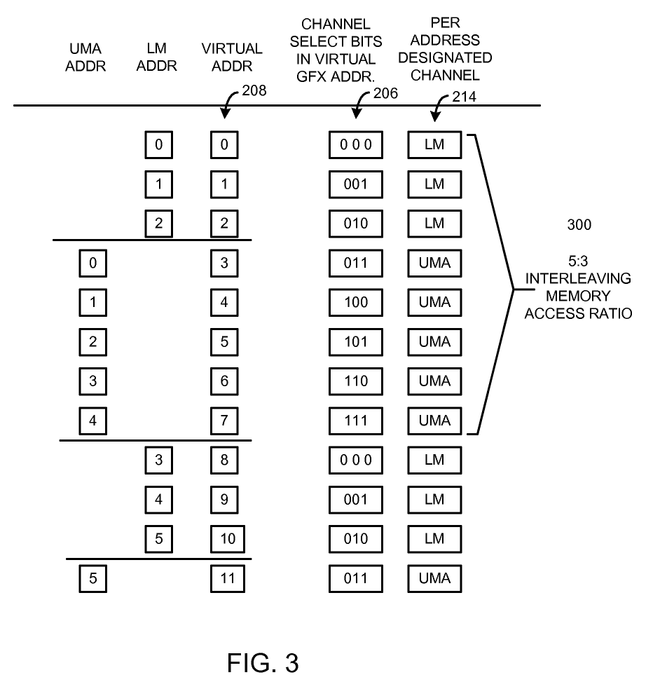

Referring also to FIG. 3, the operation of the circuit of FIG. 2 will be described. The circuitry 102 receives a virtual address 205 with channel bits 206 in number greater than or equal to a number of memory channels from any client such as a CPU, graphics processor or other suitable client, and also processes the virtual address with the channel select bits 205 to interleave memory access to either the memory 104 or memory 108 based on the channel select bits. It also interleaves memory accesses based on a programmable interleave ratio stored in the ratio map register 202. In this example, the data 210 representing the non 1:1 interleaving memory access ratio may be bits stored in the ratio map register 202 that identifies, in this example, a 5:3 (e.g., non 1:1) interleaving ratio wherein five memory accesses (each of equal length) are performed with the memory 104 and three memory accesses (each of equal length) are performed with the local memory 108. Also by way of example, the virtual address with channel select bits 205 may be produced by the processor 112 executing one or more applications that utilize the coprocessor 118.

The ratio map register 202 is a programmable register and may be programmed, for example, during startup as part of a BIOS operation and may be set to a ratio that was determined empirically based on a laboratory analysis of various programs that are expected to be operating on the device 100 to provide an optimum memory access configuration. By way of example, the non 1:1 memory access ratio may be different for an application such as a 3D game that may utilize the coprocessor 118 and the dedicated memory 108 often and require real time processing as opposed to a word processor application that may also use the coprocessor 118, such as a graphics processing unit, but with less real time data output requirements and as such, the system memory 104 may be used more often. The non 1:1 interleaving ratio is a function of, for example, the characteristics of the multiple channels such as the latency of the channels, the bandwidth of the channels, and the power levels of the channels. If an executing application is latency sensitive, then a different ratio may be programmed during startup, for example, to accommodate the particular type of application running. It may also be desirable to have a more dynamic programming of the ratio depending upon the type of application or peripheral devices being employed in the device.

FIG. 3 diagrammatically illustrates a 5:3 interleaving memory access ratio shown as 300 based on channel select bits 206 that are part of the virtual address 205. In this example, a virtual address 0 means that the circuitry 102 will translate the virtual address to be physical address 0 of the local memory 108. Likewise a virtual address of 1 also designated as channel select bit 1 indicates that the circuitry 102 will produce a physical memory address 1 for access to the local memory 108. The virtual address 7, for example, along with channel select bits 111 designate that the physical address will be a unified memory address of memory 104 and a particular address number 4 of the system memory frame buffer 114.

In operation, the control logic 200 receives channel select bits 206 of a virtual address 205 and determines a per-address designated channel 214 based on the channel select bits. For example, as shown in FIG. 3, if the channel select bits are 011, the per-address designated channel 214 will indicate that the system memory (UMA) or memory 104 is to be accessed based on the virtual address 205. The virtual address 205 is actually in this example, virtual address 3. The channel select bits 206 are used by the control logic 200 to determine which bit in the ratio map register is to be considered. In this example, assuming an 8 bit register size, and assuming in the example the virtual address is the third address, the fourth bit in the ratio map register 202 is analyzed to determine which memory the virtual address should be translated to. The translation logic 204 also utilizes the data from the ratio map register 202 to translate the virtual address to the appropriate physical memory address. Shown for example, in FIG. 3 again assuming that the virtual address is 3 and the channel select bits are 011, the translated physical address will be address 0 in the system memory 104.

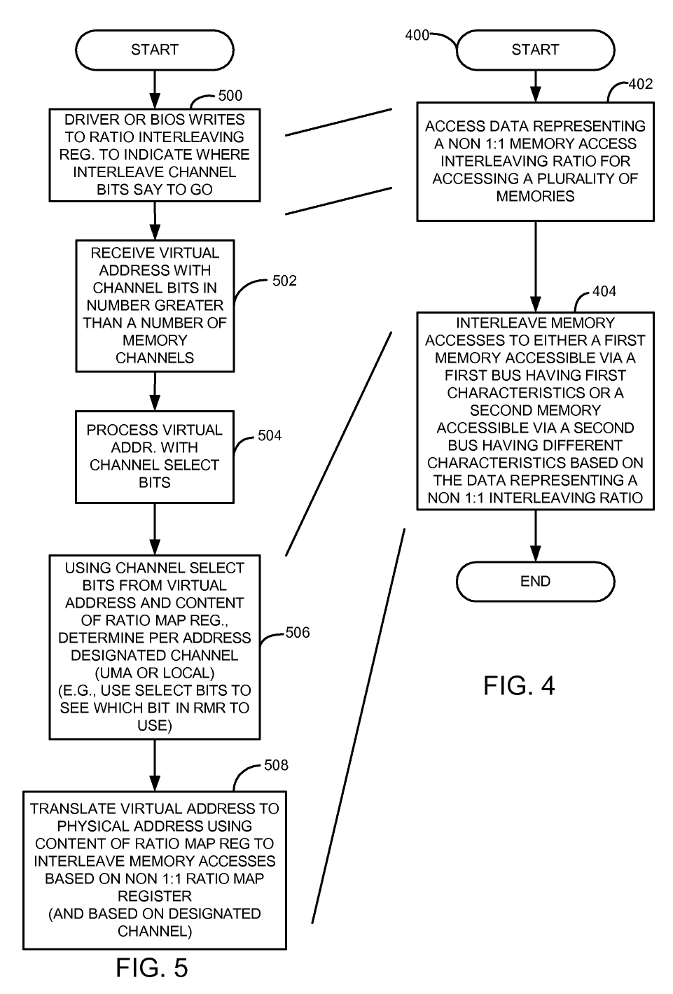

Referring to FIG. 4, a method for accessing memory is shown which begins, for example, at block 400 and as shown in block 402, includes accessing the data 210 representing a non 1:1 memory access interleaving ratio for accessing a plurality of memories having different characteristics. The method also includes, as shown in block 404, interleaving memory accesses to at least either a first memory 104 accessible via a first bus 108 having first characteristics, or with a second memory 108 accessible via a second bus 110 having different characteristics from the bus 106, based on the data 210 representing a non 1:1 interleaving ratio.

The above method may be carried out, for example, by the circuit 102, or any other suitable structure including, for example, the use of the processor 112 executing a BIOS or driver application initially store the non 1:1 interleaving ratio data 210 in the programmable register 202.

FIG. 5 shows in more detail, one example of a method for accessing memory that includes, for example, as shown in block 500, that a driver, for example, executing on the processor 112 or a BIOS, rights to the ratio interleaving register or ratio map register 202 to indicate where interleaving channel bits 206 indicate that the memory access should go.

As shown in block 502, once the programmable ratio map register is programmed, the method includes receiving the virtual address 205 with channel bits 206 in number greater than or equal to a number of memory channels as shown in block 502. As shown in block 504, the method includes processing the virtual address with the channel select bits 205 such as may be performed, for example, by the circuitry 102 that interleaves the memory accesses as described above. Interleaving the memory accesses is shown, for example, in blocks 506 and 508 wherein the method includes as noted above, using the channel select bits 206 from the virtual address 205 and the content of the ratio map register 202, namely the ratio information 210, to determine the per-address designated channel information 214. The method also includes translating, such as by the translation logic 204, the virtual address to the physical address using the content of the ratio map register 202, namely data 210, and the per-address designated channel information 214, to interleave memory accesses to the unified memory frame buffer 114 or the local frame buffer and memory 108 based on a non 1:1 ratio map register 202, namely the data therein 210. The circuitry 102 receives the virtual address containing the memory channel select bits via the data bridge, for example, as sent by the processor 112, or internally via an internal bus (not shown) via the processing circuitry in the coprocessor 118. As noted above, the method includes storing the non 1:1 address memory access interleaving ratio or the data representing the ratio 210 in the programmable register 202, such as during power up or any other suitable time.

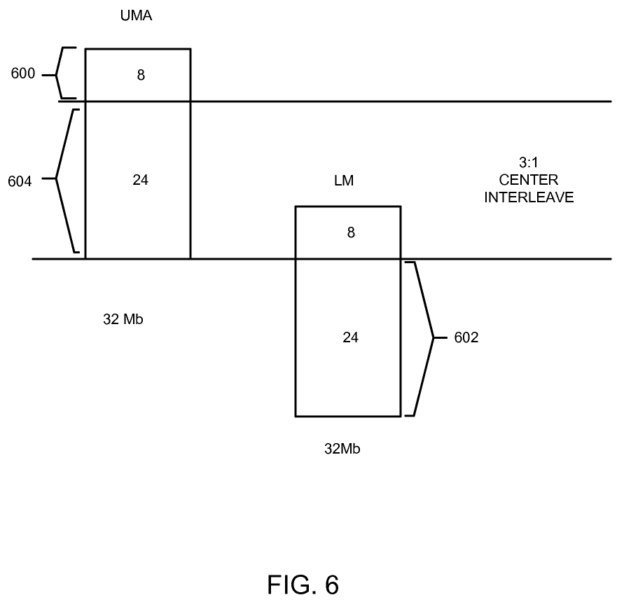

FIG. 6 illustrates another example of a non 1:1 memory access interleaving scheme wherein an address map defines three different memory access schemes. For example, the memory map may indicate that a first set of addresses 600 are for unified memory access only and memory addresses 602 are dedicated for local memory access only. Memory addresses 604 are for an interleave memory operation as described above, for example, and in this case is shown to be a 3:1 interleaving ratio. In this example, address range detection logic which may be, for example, part of the virtual address translation logic determines which address range an incoming address is attempting to address and determines whether it be in the interleave addresses range, the UMA only address range or the local memory only address range 604, 600 and 602, respectively. An address map register stores data indicating which memory addresses define each range. The address range detection logic accesses the address map register in response to an incoming address and uses the address map information to make the above determinations. If the virtual address falls within the address range 604, the interleaving scheme as described above is employed utilizing the ratio map register that would indicate in this example a 3:1 interleave ratio between a unified memory architecture frame buffer and a local frame buffer. As such, the circuitry 102 interleaves memory access to either the first memory or the second memory on a non 1:1 interleaving memory access ratio basis.

If the address points to a local memory only address, such as address 602, no interleaving scheme is necessary. Similarly, if the address is for a unified memory only range or system memory frame buffer access such as addresses 600, again no interleaving operation is necessary. Among other advantages, this scheme may allow the use of local memory only which may be the lowest power consuming memory access structure to be used during CPU sleep modes. Using UMA only area may be used, for example, during high memory capacity games or other applications executing on the device. Using the interleaving addressing scheme may be useful for other types of applications and memory consumption modes as desired. Other advantages will be recognized by those of ordinary skill in the art.

By way of example, assuming the coprocessor (e.g., a graphics engine in the coprocessor) uses_{—}256 byte addressing (i.e. sends A[7:0] to the memory controller) and assuming that there are two pools of memory with 32 bytes each (local memory and UMA), when the coprocessor accesses one of the pools, it gets at least two bytes worth of data. (i.e. A[0] is not used for determining the channel). For a ratio of 3:1 (UMA:LM), a ratio mask[7:0] of: (LM, UMA, UMA, UMA, LM, UMA, UMA, UMA) and that Ratio[0]=LM, Ratio[1]=UMA, the last 8 bytes of local memory are interleaved with the first 24 bytes of UMA.

Therefore, if one walked from (gfx address=0) up thru the 64 bytes of memory, one would see:
addresses 0-23 hits local memory,
addresses 24-55 hit ratio area (i.e. interleave_start=24)
addresses 56-63 hit UMA (i.e. interleave_end=56)
there's no memory for addresses>=64

Since it is assumed that a minimum of 2 bytes is returned, A[3:1] can be used as channel select bits into ratio mask.

As one example then, if gfx address is <24, address is<interleave_start, address targets local memory and address to local memory is unmodified.

If gfx address is >=56, address is>=interleave_end, address targets UMA and address to UMA memory is (gfx_address−56+24).

For accesses to the interleave range . . .

Addresses 24,25 are local memory; addresses 26,27,28,29,30,31 are UMA.

Addresses 32,33 are local memory; addresses 34,35,36,37,38,39 are UMA.

Addresses 40,41 are local memory; addresses 42,43,44,45,46,47 are UMA.

If gfx address is 45, we subtract interleave_start first so, new address is 45−24=21.

Using bits A[3:1] of new address (=010), we see UMA is selected.

Therefore, the address to UMA is:
divide new address by 16//which group of 16 (1)
multiple this by 6//since ratio is 2:6 (6)
modify based on position in ratio mask//2nd UMA in register (6+1=7)
multiple by 2//2 bytes per access (14)
add in A[0]//done (15)

For local memory, calculations are similar but, interleave_start gets added back in.

Unlike known systems, the above methods and apparatus may provide an improved memory access scheme that takes into account bus bandwidth differences, and/or latency differences and/or power differences by utilizing a non 1:1 memory access interleaving scheme between a unified memory architecture and a dedicated memory associated with multiple processors, in one example. Other advantages will also be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for accessing memory comprising:
accessing data representing a non 1:1 memory access interleaving ratio for accessing a plurality of memories; and
interleaving memory access to either a first memory accessible via a first bus having first characteristics or a second memory accessible via a second bus having different characteristics based on the data representing the non 1:1 interleaving memory access ratio.

2. The method of claim 1 comprising receiving a virtual address containing memory channel select bits wherein a number of memory channel select bits is greater than a number of memory channels associated with the combination of the first memory and second memory.

3. The method of claim 2 wherein storing comprises storing the data representing the non 1:1 address memory access interleaving ratio as a plurality of bits in a programmable register.

4. The method of claim 3 comprising using the channel select bits of the virtual address to identify which of the first and second memories to access based on the plurality of bits that define the memory access interleaving ratio.

5. A method for accessing memory comprising:
accessing data representing a non 1:1 memory access interleaving ratio; and
interleaving memory access to either a unified memory containing frame buffer memory or a local frame buffer based on the data representing the non 1:1 interleaving ratio wherein the unified memory is accessible via a first bus having first characteristics and wherein the local frame buffer is accessible via a second bus having different characteristics.

6. The method of claim 5 comprising receiving a virtual address containing memory channel select bits wherein a number of memory channel select bits is greater than a number of memory channels associated with the combination of the first memory and second memory.

7. The method of claim 6 wherein storing comprises storing the non 1:1 address memory access interleaving ratio in a programmable register.

8. An apparatus comprising:
circuitry operative to interleave memory access to either a first memory accessible via a first bus having first characteristics or a second memory accessible via a second bus having different and second characteristics, based on data representing a non 1:1 interleaving memory access ratio.

9. The apparatus of claim 8 wherein the circuitry comprises a programmable register that stores the data representing the non 1:1 interleaving ratio and wherein the circuitry is operative to process a virtual address containing memory channel select bits wherein a number of memory channel select bits is greater than a number of memory channels associated with the combination of the first memory and second memory.

10. The apparatus of claim 9 comprising:
a first processor;
a second processor;
and wherein the first memory is shared memory and is operatively coupled to the first processor via the first bus and to the second processor via the first bus;
and wherein the second memory is accessible to the second processor via the second bus and wherein the circuitry comprises a memory controller operatively coupled to the second memory and wherein the circuitry is operative to use the channel select bits of the virtual address to identify which of the first and second memories to access based on the plurality of bits that define the memory access interleaving ratio.

11. The apparatus of claim 10 comprising a display operatively coupled to at least one of the processors.

12. The apparatus of claim 8 comprising address range detection logic that determines which address range an incoming address is attempting to address and determines whether it is in an interleave addresses range, shared memory only address range or a local memory only address range and if in the interleave address range, the circuitry interleaves memory access to either the first memory or the second memory on a non 1:1 interleaving memory access ratio basis.

13. An apparatus comprising:
circuitry operative to receive a virtual address with channel bits in number greater than a number of memory channels and process the virtual address with the channel select bits greater in number than the number of memory channels to interleave memory access to either a first memory accessible via a first bus having first characteristics or a second memory accessible via a second bus having different characteristics based on the virtual address.

14. The apparatus of claim 13 comprising:
a first processor;
a second processor;
and wherein the first memory is shared memory and is operatively coupled to the first processor via the first bus and to the second processor via the first bus;
and wherein the second memory is accessible to the second processor via the second bus and wherein the circuitry comprises a memory controller operatively coupled to the second memory and wherein the circuitry is operative to use the channel select bits of the virtual address to identify which of the first and second memories to access based on the plurality of bits that define the memory access interleaving ratio.
